(19) United States
(12) Patent Application Publication
(10) Pub. No.: US 2006/0084184 A1
(43) Pub. Date: Apr. 20, 2006

(54) Reagents for urine-based immunological assays

(75) Inventors: Huaizhong Hu, Madison, WI (US); Brian D. Aizenstein, Madison, WI (US)

Correspondence Address: David A. Casimir;MEDLEN & CARROLL, LLP, Suite 350, 101 Howard Street, San Francisco, CA, 94105, US

(73) Assignee: Renovar Incorporated, Madison, WI (US)

(21) Appl. No.: 10/968,597

(22) Filed: Oct. 19, 2004

(51) Int. Cl. G01N 1/00

(52) U.S. Cl. 436/174

(57) ABSTRACT

The present invention provides compositions and methods for detecting analytes in urine. In particular, the present invention provides reagents for accurately detecting antigens in urine through the use of antibody-based assays.

### FIELD OF INVENTION

The present invention provides compositions and methods for detecting analytes in urine. In particular, the present invention provides reagents for accurately detecting antigens in urine through the use of antibody-based assays.

### BACKGROUND OF INVENTION

Urine is the liquid waste product secreted by the kidneys, consisting primarily of water, urea, creatine, uric acid and salts (e.g., sodium, potassium, magnesium, ammonium, calcium, chloride, and phosphate). However, its constituents and volume vary widely from day to day and from person to person, as urination is the process by which normal fluid and electrolyte homeostasis is maintained. This variation is greatly exacerbated by diet, disease and drug intake. For instance with regard to pH (normal range 4.6 to 8.0), a diet high in meat products can make urine more acidic, while a diet high in citrus fruits, vegetables or dairy products can make urine more alkaline. Likewise, emphysema, diabetic ketoacidosis, and diarrhea can lower urine pH, while renal failure, urinary tract infection and vomiting can increase urine pH. Similarly, the use of diuretics can make urine more acidic, while the use of antacids can make urine more basic.

Importantly, urine chemistry and its variation present problems in using urine specimens as samples for biological assays. Thus, what are needed are methods and compositions for eliminating interference with analyte detection caused by vagaries in urine chemistry. In particular, it would be desirable to have the means of adapting immunoassays designed for measuring antigen concentrations in serum for use with urine samples. This need is especially acute in the field of home test kits.

### SUMMARY OF INVENTION

The present invention provides compositions and methods for detecting analytes in urine. In particular, the present invention provides reagents for accurately detecting antigens in urine through the use of antibody-based assays.

For example, the present invention provides a kit for preparing a urine sample for an assay, comprising: i) a sample additive composition comprising a high concentration salt buffer (or solid salt), and ii) immunoassay reagents for detecting an analyte of interest in a urine sample. In preferred embodiments, the salt buffer, when mixed with an equal volume of urine would provide a concentration of the salt equivalent to approximately 400 mM NaCl in the mixture. It is noted that the kit need not be configured to require a one-to-one buffer urine mixture. The buffer could be provided as a 5×, 10×, etc. buffer.

In some embodiments, the kit further comprises instructions for using the kit to detect the analyte of interest. Instructions include, but are not limited to, instructions for mixing buffers with urine, use of control samples, carrying out the experiments, reading data, interpreting data, etc. Instructions may include those items required by regulatory institutions for use of the kit as an in vitro diagnostic product or other type of product.

The present invention is not limited by the nature of the salt used. In some embodiments, the salt comprises an acetate, carbonate, chloride, cyanide, nitrate, nitrite, phosphate, and/or sulfate.

The present invention is also not limited by the nature of the assay used. In some preferred embodiments, the assay is an immunoassay selected (e.g., agglutination assay, immunodiffusion assay, radioimmunoassay or enzyme linked immunosorbent assay). In some preferred embodiments, the immunoassay comprises a reporter comprising a calorimetric reporter, radioactive reporter, fluorescent reporter, luminescent reporter, or electroactive reporter. In preferred embodiments, the assay is quantitative or semi-quantitative (e.g., in the presence of the salt buffer, but not in its absence).

The present invention is also not limited by the nature of the analyte that is detected. In preferred embodiments, the analyte is a protein antigen (e.g., cytokine, a chemokine, a growth factor, an antibody, or a hormone). Certain preferred cytokines include, but are not limited to, an interferon, an interleukin, and a tumor necrosis factor. Certain preferred chemokines include, but are not limited to, a C chemokine, CC chemokine, and CXC chemokine. Particularly preferred analytes are those associated with kidney rejection or kidney disease (e.g., those described in U.S. patent application Ser. No. 10/313,807, herein incorporated by reference in its entirety).

The present invention further provides methods for preparing a urine sample for an immunoassay, comprising the steps of a) providing: i) a sample additive composition comprising salt, and ii) immunoassay reagents for detection of a protein antigen (or any of the kits described above); and b) contacting said urine sample with said sample additive composition to yield a urine test sample, wherein said urine test sample has a concentration of said salt equivalent to approximately 400 mM NaCl. In preferred embodiments, the method further comprises the step of detecting the presence or absence of the analyte of interest.

Definitions

To facilitate an understanding of the present invention, a number of terms and phrases are defined below:

As used herein, the term “urea” refers to a soluble weakly basic nitrogenous compound CO(NH₂)₂ formed in the liver via the urea cycle from ammonia produced by the deamination of amino acids. Urea is the principal end product of protein catabolism and is cleared from the blood by the kidneys into urine.

As used herein, the term “salt” refers to stable compound composed of a cation bound to an anion. Salts are typically formed in a chemical reaction between a base or a metal and an acid yielding a salt and water (e.g., NaOH+HCl=NaCl+H₂O). The term salts refers to but is not limited to acetates, carbonates, chlorides, cyanides, nitrates, nitrites, phosphates, and sulfates.

The term “serum” as used herein refers to the cell-free portion of the blood from which the fibrinogen has been separated in the process of clotting. The cell free portion of the blood (plasma) has a pH within the narrow range of 7.35 to 7.45 in healthy individuals.

The term “urine” as used herein refers to an aqueous waste product secreted by the kidneys, consisting primarily of urea, creatine, uric acid and salts (e.g., sodium, potassium, magnesium, ammonium, calcium, chloride, and phosphate). Normal pH range of urine is in the wide range of 4.6 to 8.0.

As used herein, the term “sample” is used in its broadest sense. In one sense, it is meant to include a specimen or culture obtained from any source, as well as biological and environmental samples. Biological samples may be obtained from animals (including humans) and encompass fluids, solids, tissues, and gases. Biological samples include urine and blood products, such as plasma, serum and the like. Such examples are not however to be construed as limiting the sample types applicable to the present invention.

As used herein, the term “immunoglobulin” or “antibody” refer to proteins that bind a specific antigen. Immunoglobulins include, but are not limited to, polyclonal, monoclonal, chimeric, and humanized antibodies, Fab fragments, F(ab′)₂ fragments, including immunoglobulins of the following classes: IgG, IgA, IgM, IgD, IbE, and secreted immunoglobulins (sIg). Immunoglobulins generally comprise two identical heavy chains and two light chains. However, the terms “antibody” and “immunoglobulin” also encompass single chain antibodies and two chain antibodies.

As used herein, the term “analyte” refers to a substance being measured in an analytical procedure. The term “antigen” refers to a substance capable, under appropriate conditions, of inducing a specific immune response and of reacting with the products of that response, which in preferred embodiments is a specific antibody. Antigens may be soluble substances, such as toxins and foreign proteins, or particulate, such as bacteria and tissue cells, however, only the portion of the antigen molecule known as the antigenic determinant or epitope combines with antibody.

The terms “specific binding” or “specifically binding” when used in reference to the interaction of an antibody and a protein or peptide means that the interaction is dependent upon the presence of a particular structure (i.e., the antigenic determinant or epitope) on the protein; in other words the antibody is recognizing and binding to a specific protein structure rather than to proteins in general. For example, if an antibody is specific for epitope “A,” the presence of a protein containing epitope A (or free, unlabelled A) in a reaction containing labeled “A” and the antibody will reduce the amount of labeled A bound to the antibody.

As used herein, the terms “non-specific binding” and “background binding” when used in reference to the interaction of an antibody and a protein or peptide refer to an interaction that is not dependent on the presence of a particular structure (i.e., the antibody is binding to proteins in general rather that a particular structure such as an epitope).

As used herein, the term “reagents for detection of an analyte” refers to reagents specific for the detection of a given analyte (e.g., chemokines such as MIP-1α, MIP-3α, and MIP-1β), for example, in urine of a subject. In some embodiments, the reagent is an antibody specific for the analyte of interest. In some embodiments, the reagents further comprise additional reagents for performing detection assays, including, but not limited to, controls, buffers, reporters, etc.

The terms “label,” “marker” and “reporter” as used herein refer to any atom or molecule that can be used to provide a detectable (preferably quantifiable) signal. Labels may provide signals detectable by fluorescence, radioactivity, colorimetry, gravimetry, X-ray diffraction or absorption, magnetism, enzymatic activity, and the like. A label may be a charged moiety (positive or negative charge) or alternatively, may be charge neutral.

As used herein, the term “instructions for using said kit for detecting an analyte” refers to instructions for using the reagents contained in the kit for the detection of analyte in a urine sample from a subject. In some embodiments, the instructions further comprise the statement of intended use required by the U.S. Food and Drug Administration (FDA) in labeling in vitro diagnostic products.

As used herein, the term “subject” refers to any animal (e.g., a mammal), including, but not limited to, humans, non-human primates, rodents, and the like, which is to be the recipient of a particular diagnostic test or treatment. Typically, the terms “subject” and “patient” are used interchangeably herein in reference to a human subject.

As used herein, the term “non-human animals” refers to all non-human animals including, but are not limited to, vertebrates such as rodents, non-human primates, ovines, bovines, ruminants, lagomorphs, porcines, caprines, equines, canines, felines, aves, etc.

“Amino acid sequence” and terms such as “polypeptide” or “protein” are not meant to limit the amino acid sequence to the complete, native amino acid sequence associated with the recited protein molecule.

General Description of Invention

The present invention provides compositions and methods for detecting one or more analytes in urine. In some embodiments, the present invention provides reagents for accurately detecting an antigen of interest in a urine sample through the use of an immunoassay. In particular, the present invention provides novel, non-invasive methods for utilizing urine samples for measuring protein analyte concentrations with sensitivities and specificities contemplated to approach that of assays utilizing serum samples. The technology of the present invention provides the further advantage of allowing home testing by patients.

I. Buffering and Dilution of Urine

Although several commercially available immunoassay test kits advertise that they are suitable for use with both serum and urine samples, their utility in detecting protein analytes in urine is questionable at best. This is thought to be due simply to the extreme day-to-day and person-to-person variations in urine salt concentrations and pH, two conditions known to effect antibody binding. For this reason, during development of the present invention, multiple sample additives comprising buffer concentrates were tested for their ability to eliminate the considerable immunoassay result inconsistencies encountered when testing urine samples for antigens of interest. As described in detail in Example 1, the addition of 2× phosphate buffered saline (PBS), Tris buffer or Hepes buffer (normalize pH) to urine samples was not effective in permitting the consistent use of urine in an exemplary immunoassay. Moreover, the dilution of urine samples with an aqueous solution (decrease salt concentration) also did not solve the immunoassay problems.

II. Optimization of Urea and Salt Concentration in Urine

In order to create artificial urine for further development of the present invention, the inventors prepared an artificial urine solution comprising high urea concentrations. Surprisingly, reasonable results were obtained when using the exemplary immunoassay to detect an analyte of interest added to the artificial urine solution. Reasonable results were also obtained when using the exemplary immunoassay to detect an analyte of interest in urine samples to which excess urea and salt had been added. Further experimentation revealed that high levels of salt added to the experimental sample provided reliable and consistent results. While the present invention is not limited to any mechanism of action and an understanding of the mechanism of action is not necessary to practice the present invention, it is contemplated that the high salt levels added to urine reach a threshold level above which assay performance is not significantly hindered by sample-to-sample variations.

Further tests revealed that, for some analytes, there is a threshold salt concentration that when exceeded in urine samples, diminishes the improved results achieved with added salt. In contrast, further tests revealed that there is an optimal salt concentration range in urine samples, that above and below which leads to poor assay performance. Thus, while additional high salt provides a general solution, for superior immunoassay performance, the optimal salt concentration range can be empirically determined.

Finally, the sample additive compositions of the present invention comprising salt, were also used to prepare urine samples for use with several commercially-available immunoassays that had been advertised as suitable for detection of an antigen of interest in both serum and urine samples, but that were not effective, as sold, with urine samples. Importantly, improved immunoassay results were obtained when the sample additive composition of the present invention was added to the urine samples. Thus, the present invention also provides compositions for enhancing the performance of immunoassays of the prior art.

A. Reagents

In some embodiments, the present invention provides sample additive compositions comprising salt or buffers containing high salt concentrations for addition to urine samples for improved immunoassay performance. In some preferred embodiments, the sample additive compositions comprise a salt concentration sufficient to raise the final salt concentration in the urine to approximately 200-600 mM range (e.g., approximately 400 mM). Ideal ranges for a particular analyte may be readily identified by conducting a simple screen of varying salt concentrations versus analyte/antibody binding and/or to assess quantitative accuracy.

The present invention is not limited by the nature of the salt used. Any of a wide variety of salts including, but not limited to, sodium chloride, potassium chloride, and the like, find use with the present invention.

B. Kits

In some embodiments, the present invention provides immunoassay kits comprising a sample additive composition comprising salt, for the detection of an analyte of interest in a urine sample. In some embodiments, the kits contain antibodies specific for a polypeptide antigen of interest, in addition to detection reagents and buffers. In some embodiments, the kits contain reagents and/or instructions for testing for two or more antigens of interest. In preferred embodiments, the kits contain all of the components necessary to perform a detection assay, including all controls, directions for performing assays, and any necessary directions for interpretation of the results.

In some embodiments, the kits contain an assay in a test strip format. In such embodiments, the detection reagent (e.g., antibody), as well as any control or secondary antibodies, are affixed to a solid support. In some embodiments, the solid support is a test strip suitable for dipping into a solution of urine (See e.g., U.S. Pat. Nos. 6,352,862, 6,319,676, 6,277,650, 6,258,548, and 6,248,596, each of which is herein incorporated by reference). In some embodiments, the kits are marketed as in vitro diagnostics or as home testing products.

For example, in some embodiments, the kits contain a high salt concentration buffer that is added to a urine sample. The sample is then exposed to detection reagents (e.g., antibodies). A detectable signal (e.g., colorimetric, fluorescent, etc.) is observed or detectable if the analyte of interest is present in the urine sample. Control reagents may be provided in the kit (e.g., negative and positive control reagents for the analyte of interest).

Experimental

The following examples are provided in order to demonstrate and further illustrate certain preferred embodiments and aspects of the present invention and are not to be construed as limiting the scope thereof.

In the experimental disclosure which follows, the following abbreviations apply: eq (equivalents); M (Molar); μM (micromolar); N (Normal); mol (moles); mmol (millimoles); μmol (micromoles); nmol (nanomoles); g (grams); mg (milligrams); μg (micrograms); ng (nanograms); 1 or L (liters); ml (milliliters); μl (microliters); cm (centimeters); mm (millimeters); μm (micrometers); nm (nanometers); ° C. (degrees Centigrade); U (units), mU (milliunits); min. (minutes); sec (seconds); % (percent); kb (kilobase); bp (base pair); WT (wild type); mAb (monoclonal antibody), ELISA (enzyme linked immunosorbent assay); 1° (primary); 2° (secondary); and OD (optical density).

### EXAMPLE 1

### Adjustment of Urine Salt Concentration and pH for Use with an In-House Immunoassay

This example describes the unsuccessful use of urine in a standard immunoassay by addition of 2× traditional buffers to urine samples or by 2× dilution of urine samples with water.

Buffering Urine (PBS, Tris, Hepes)

To evaluate the ability of buffers to neutralize the pH of urine samples, pH of 8 urine samples were compared before and after addition of equal volumes of different buffering solutions. It was observed that HEPES buffer was most effective. It was noted that neither the standard phosphate buffers nor a standard tris buffer were able to adjust the pH of all samples to the neutral range. For this reason, HEPES was chosen as the buffering component of this urine buffer.

To compare the utility of various buffering solutions, a number of urine samples were assayed “as is” and “spiked” with varying amounts of chemokine standard protein alongside these same standard protein concentrations in standard buffer diluted with water. The urine samples were then diluted with equal volumes of the various buffers. A diluent was looked for that eliminated or minimized the differences observed between urine samples spiked with known amounts of the chemokine standard (after background correction for inherent chemokine). Comparison of standard PBS buffer to tris buffer (TBS) and HEPES buffer demonstrated that HEPES buffer provided the most consistent assay performance (signal strength/unit of analyte) across numerous urine samples and chemokine analytes. However, simply buffering the urine did not provide desired results.

Dilution of Urine

Chemokine standard proteins were added, to a concentration of 250 pg/ml, to several different urine samples and to a variety of buffer solutions whose utility as a urine diluent were being assessed. Each urine sample was diluted serially into each of the buffer solutions and a Luminex assay was performed to determine whether sample dilution improved the ability to accurately measure the chemokine concentration by correlating the fluorescence intensity to a standard curve generated in a standardized buffer solution. The buffer described above, demonstrated the most consistent results across urine samples and dilutions. However, diluation and buffering did not provide desired results.

### EXAMPLE 2

### Adjustment of Salt Concentration for use with an In-House Immunoassay

This example describes the successful use of urine in a standard immunoassay by addition of exogenous salts.

Controlled amounts of standard chemokine proteins were added to a number of undiluted urine samples. These samples were than diluted 2-fold in a buffer containing either standard (physiological) NaCl concentration or buffer containing 800 mM NaCl (final conc.=400 mM). Unspiked urine samples diluted identically were prepared as controls. Standard immunoassays were performed and demonstrated that when the final salt concentration was increased to 400 mM, both the percent recovery of chemokine and the consistency across different urine samples were improved.

### EXAMPLE 3

### Adjustment of Commercially-Available Immunoassays

This example describes the successful use of urine in a commercially-available immunoassays by addition of exogenous salts.

RayBiotech Immunoassays (Norcross, Ga.)

A commercially available product to detect 120 different proteins from biological fluids was analyzed for the ability to detect these analytes in human urine samples. This product is based on ‘capture’ antibodies covalently attached to a membrane in an array pattern, incubated with sample, and after washing, incubating with a pool of secondary ‘reporter’ antibodies and detection. Several urine samples were initially assayed using the buffers as provided and recommended by the manufacturer. Very low overall reactivity was observed and it was noted that the strength of the signals for “positive control” samples was lower than expected. When the urine samples were diluted with the buffer solution of the present invention instead of dilution buffer provided by the manufacturer, higher signal intensities were observed for the “positive control” samples, and the overall reactivity of the urine samples was increased.

Upstate Immunoassays (Upstate Biotechnology, Lake Placid, N.Y.)

A commercially available product to detect and quantify analytes present in biological fluids based on the Luminex microsphere platform was used to confirm the utility of the previously described urine buffer. A number of urine samples were analyzed after dilution with either the manufacturer supplied dilution buffer or the previously described urine buffer. Samples were analyzed ‘as is’ and after the addition of known amounts of standard protein. It was noted that different urine samples produced standard curves with different ‘slopes’ when diluted with the manufacturer supplied buffer, making the generation of a broadly applicable standard curve and quantification of analyte difficult. The buffer of the present invention minimized this effect.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A kit for preparing a urine sample for an assay, comprising: i) a sample additive composition comprising a high concentration salt buffer, and ii) immunoassay reagents for detecting an analyte of interest in a urine sample, wherein said salt buffer, when mixed with an equal volume of urine provides a concentration of said salt of 200-600 mM in said mixture.

2. The kit of claim 1, further comprising instructions for using said kit to detect said analyte of interest.

3. The kit of claim 1, wherein said salt comprises one or more of the group consisting of an acetate, carbonate, chloride, cyanide, nitrate, nitrite, phosphate, and sulfate.

4. The kit of claim 1, wherein said assay is an immunoassay selected from the group consisting of an agglutination assay, immunodiffusion assay, radioimmunoassay and enzyme linked immunosorbent assay.

5. The kit of claim 4, wherein said immunoassay comprises a reporter selected from the group consisting of a colorimetric reporter, radioactive reporter, fluorescent reporter, luminescent reporter and electroactive reporter.

6. The kit of claim 1, wherein said assay is quantitative or semi-quantitative.

7. The kit of claim 1, wherein said analyte is a protein antigen.

8. The kit of claim 7, wherein said protein antigen is selected from the group consisting of a cytokine, a chemokine, a growth factor, an antibody, and a hormone.

9. The kit of claim 8, wherein said cytokine is selected from the group consisting of an interferon, an interleukin, and a tumor necrosis factor.

10. The kit of claim 8, wherein said chemokine is selected from the group consisting of a C chemokine, CC chemokine, and CXC chemokine.

11. The kit of claim 1, wherein said immunoassay comprises a detection antibody that binds to said analyte.

12. A method for preparing a urine sample for an immunoassay, comprising:
a) providing: i) a sample additive composition comprising salt, and ii) immunoassay reagents for detection of a protein antigen;
b) contacting said urine sample with said sample additive composition to yield a urine test sample, wherein said urine test sample has a concentration of said salt of 200-600 mM.

13. The method of claim 12, further comprising the step of detecting said protein antigen in said urine test sample using said immunoassay reagents.

14. The method of claim 12, wherein said salt comprises one or more of the group consisting of an acetate, carbonate, chloride, cyanide, nitrate, nitrite, phosphate, and sulfate.

15. The method of claim 12, wherein said assay is an immunoassay selected from the group consisting of an agglutination assay, immunodiffusion assay, radioimmunoassay and enzyme linked immunosorbent assay.

16. The method of claim 15, wherein said immunoassay comprises a reporter selected from the group consisting of a calorimetric reporter, radioactive reporter, fluorescent reporter, luminescent reporter and electroactive reporter.

17. The method of claim 12, wherein said assay is a quantitative or a semi-quantitative assay.

18. The method of claim 12, wherein said protein antigen is selected from the group consisting of a cytokine, a chemokine, a growth factor, an antibody, and a hormone.

19. The method of claim 18, wherein said cytokine is selected from the group consisting of an interferon, an interleukin, and a tumor necrosis factor.

20. The kit of claim 18, wherein said chemokine is selected from the group consisting of a C chemokine, CC chemokine, and CXC chemokine.
